(19) United States
(12) Patent Application Publication
(10) Pub. No.: US 2022/0045572 A1
(43) Pub. Date: Feb. 10, 2022

(54) MOTOR AND EXHAUST METHOD FOR MOTOR CAVITY

(71) Applicant: Chang SHU, Beijing (CN)

(72) Inventor: Chang SHU, Beijing (CN)

(21) Appl. No.: 17/268,257

(22) PCT Filed: Jan. 25, 2019
(86) PCT No.: PCT/CN2019/073056

§ 371 Date: Sep. 9, 2021

(30) Foreign Application Priority Data
Aug. 14, 2018 (CN) 201810923497.2
Aug. 14, 2018 (CN) 201821307696.2

(51) Int. Cl. H02K 5/20; H02K 9/06; H02K 9/26

(52) U.S. Cl. CPC H02K 5/207; H02K 2205/09; H02K 9/26; H02K 9/06

(57) ABSTRACT

The present invention provides a motor, comprising: a housing; a motor stator located in the housing; a motor output shaft located in the housing; and an exhaust device connected to the housing and configured to exhaust air from the interior of the housing. According to an implementation mode of the present invention, a turbine device is mounted on the motor output shaft; when the motor rotates, an inner cavity of the motor is evacuated to be in a negative pressure state; the higher the motor speed, the lower the air pressure inside the motor, the higher the vacuum degree, and the smaller the frictional resistance between a rotor and the air, so that the motor speed can be effectively increased and a rotor having a relatively large diameter can be used, thereby enhancing the low speed torque while increasing the power density of the motor and facilitating the design of a high power motor.

### TECHNICAL FIELD

The present invention generally relates to the technical field of electrical motor, especially to a motor provided with an exhaust device and a method for exhausting air from a motor cavity.

### BACKGROUND

In existing motors, the resistance formed by the friction between a rotor and ambient air will correspondingly become greater as the motor speed increases, so the higher and higher speed will cause an increasingly great frictional resistance. In order to reduce the frictional resistance, only a small-diameter rotor can be used in a high-speed motor to lower the air frictional resistance, thereby limiting the torque of the motor, especially the torque at a low speed.

The contents in the Background are merely the technologies known by the inventor, instead of surely representing the prior art in the field.

### SUMMARY OF THE INVENTION

With regard to one or more of the problems existing in the prior art, the present invention provides a motor, comprising a housing; a motor stator and a motor rotor located in the housing; a motor output shaft located in the housing; and an exhaust device connected to the housing and configured to exhaust air from the interior of the housing.

According to one aspect of the present invention, the housing has an exhaust port thereon, and the exhaust device comprises an air pump in communication with the exhaust port.

According to one aspect of the present invention, the housing has an exhaust port thereon, the exhaust device comprises one or more sets of turbine rotor blades located in the housing and mounted on the motor output shaft, thereby being rotatable along with the output shaft, and the exhaust port is preferably located downstream of the turbine rotor blades.

According to one aspect of the present invention, the exhaust device comprises multiple sets of turbine rotor blades, and turbine guide blades are arranged between adjacent turbine rotor blades.

According to one aspect of the present invention, the turbine guide blades are fixed on a turbine sleeve sealed and fixed on the housing.

According to one aspect of the present invention, it further comprises a front wall of a turbine exhaust cavity mounted between the downstream of the turbine rotor blades and the housing 5, and keeping sealed with the housing 5.

According to one aspect of the present invention, the exhaust port is provided thereon with a filter and/or a check valve.

According to one aspect of the present invention, an output end of the motor output shaft is formed in an air-tight structure.

According to one aspect of the present invention, the housing has a plurality of exhaust ports thereon.

The present invention also provides a method for exhausting air from the interior of a motor, comprising: starting the motor; and exhausting the air to the exterior of a motor housing through an exhaust port on the motor housing.

According to one aspect of the present invention, the step of exhausting the air to the exterior of the motor housing comprises: exhausting the air from the exhaust port to the exterior of the motor housing by an air pump.

According to one aspect of the present invention, the step of exhausting the air to the exterior of the motor housing comprises: exhausting the air from the exhaust port to the exterior of the motor housing by one or more sets of turbine rotor blades mounted on the motor output shaft.

In the present invention, a turbine device is mounted on the motor output shaft; when the motor rotates, an inner cavity of the motor is evacuated to be in a negative pressure state; the higher the motor speed, the lower the air pressure inside the motor, the higher the vacuum degree, and the smaller the frictional resistance between a rotor and the air, so that a rotor having a relatively large diameter can be used, thereby enhancing the low speed torque and facilitating the design of a high power motor.

### BRIEF DESCRIPTION OF THE DRAWINGS

The drawings are provided for the purpose of further understanding of the present invention, and constitute part of the specification, which should serve to illustrate the present invention together with the embodiments, but make no limitation of the present invention. In the drawings:

FIG. 1 is a sectional view of a motor according to one example of the present invention;

FIG. 2 is a front view of the motor according to the one example of the present invention;

FIG. 3 is a side view of the motor according to the one example of the present invention; and

FIG. 4 is a schematic diagram of a motor according to another example of the present invention.

### DETAILED DESCRIPTION OF THE EMBODIMENTS OF THE INVENTION

Certain exemplary examples will be described below only in a brief manner. Just as those skilled in the art will appreciate, changes in various ways to the examples described herein can be carried out without departing from the spirit or scope of the present invention. Therefore, the drawings and the following description are deemed essentially exemplary, instead of limitative.

In the specification of the present invention, it need be understood that such terms as “first” and “second” are only used for the purpose of description, rather than indicating or suggesting relative importance or implicitly indicating the number of the designated technical features. Accordingly, features defined with “first” or “second” may, expressly or implicitly, include one or more of such features.

The disclosure below provides many different embodiments and examples for achieving different structures described herein. In order to simplify the disclosure herein, the following will give the description of the parts and arrangements embodied in specific examples. Surely, they are just for the exemplary purpose, not intended to limit the present invention. Besides, the present invention may repeat a reference number and/or reference letter in different examples, and such repeat is for the purpose of simplification and clarity, which denotes none of the relations among various embodiments and/or arrangements as discussed. In addition, the present invention provides examples for a variety of specific techniques and materials, but the ordinarily skilled persons in the art could be aware of an application of other techniques and/or a use of other materials.

The following description, along with the drawings, sets forth the specific examples of the present invention. It should be understood that the preferable examples described herein are only for the purpose of illustrating and explaining, instead of limiting, the present invention.

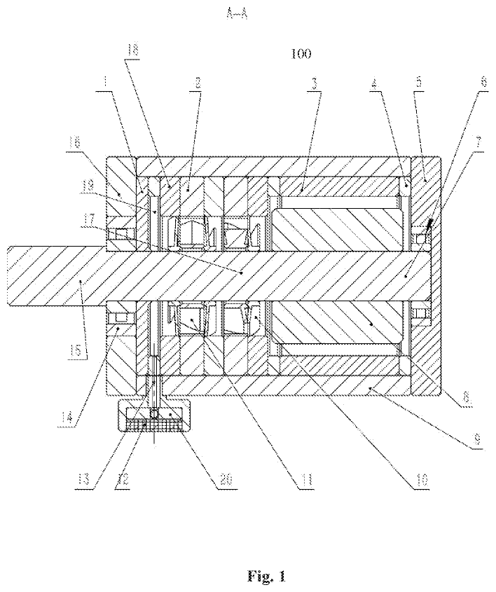

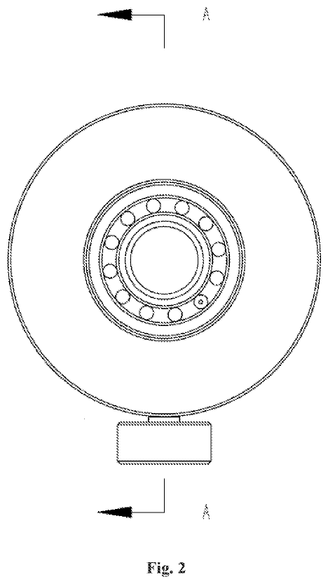

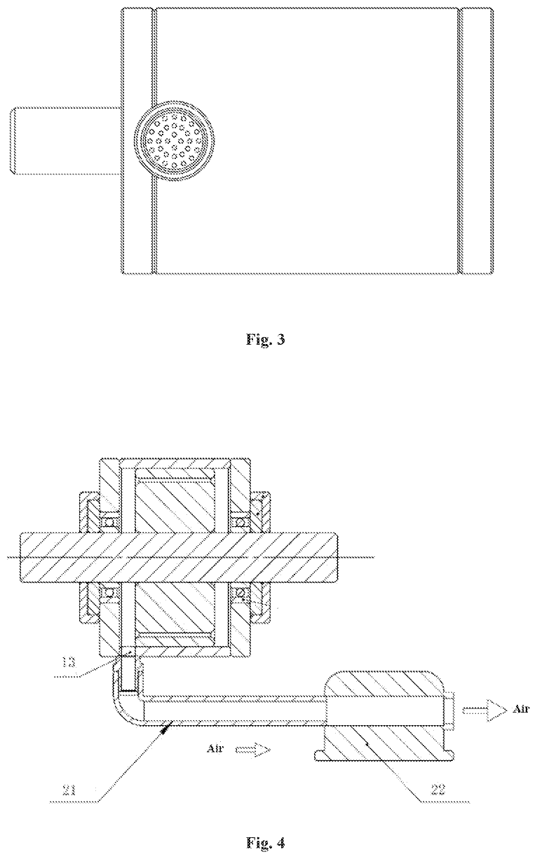

FIG. 1 is a sectional view of a motor according to one example of the present invention: FIG. 2 is a front view of the motor according to the one example of the present invention; and FIG. 3 is a side view of the motor according to the one example of the present invention.

FIG. 1 exhibits a motor 100 according to the first embodiment of the present invention. As shown in FIG. 1, the motor 100 comprises: a housing 9; a motor stator and winding 3 fixedly arranged in the housing 9 to generate a rotational magnetic field when powered; a motor rotor 8 rotatably arranged in the housing 9 to rotate when affected by the rotational magnetic field generated by the motor stator and winding 3; a motor output shaft 17 fixed together with the motor rotor 8, thereby being rotatable along with the motor rotor 8. According to the present invention, the motor 100 also comprises an exhaust device connected with the housing, arranged inside, or outside, or on the housing, and configured to be capable of exhausting air from the interior of the housing, thereby generating negative pressure in the housing to form a certain vacuum degree.

As shown in FIG. 1, the motor 100 has a rear end cover 5 at one end for closing one end of the housing 9, and for supporting a rear end 7 of the motor output shaft 17 through a rear bearing 6, for example, thereby sealing the rear bearing 6 of the motor and the rear end 7 of the output shaft in the interior of the rear end cover 5, and then using the rear end cover 5 to make an inner cavity of the motor sealed against the external environment. The motor 100 has a front end cover 16 at the other end for closing the other end of the housing 9, and also for supporting a front end 15 of the motor output shaft 17 through a front bearing 14, for example. The housing 9, the front end cover 16, and the rear end cover 7 shown in FIG. 1 are separate components, but those skilled in the art can understand that some of them can also be formed into an integral component, for example, the housing 9 and the rear end cover 7 can be integrally constructed. All these cases are within the protection scope of the present invention. Both/either the front end cover 16 and/or the rear end cover 5 can be a part of the housing 9.

The motor 100 is, for example, a single output shaft motor, namely, the one provided with an output shaft only at one end. The following description is made by taking a single output shaft motor as an example. However, those skilled in the art can understand that the present invention is not limited to a single output shaft motor, and can also be suitable for a double output shaft motor. For example, if the motor has double output shafts, namely, the one further provided with a rear output shaft, it will be necessary to add a sealing device at an inner or outer end of the rear output shaft to ensure that the inner cavity of the motor remains sealed between the rear output shaft and the rear bearing 6, that the rear bearing 6 per se remains sealed at the same time, and that sealing between the rear bearing 6 and the motor housing 9 is maintained.

It should be noted that those skilled in the art can understand that the “vacuum degree” mentioned in the present invention does not mean the absolute vacuum, which only indicates that the air pressure in the housing is made lower than the external atmospheric pressure by the exhaust device, or lower than the air pressure in the housing when it is not working.

The exhaust device will be described in detail below with reference to FIG. 1.

As shown in FIG. 1, according to one example of the present invention, the exhaust device comprises one or more sets of turbine rotor blades 10 located in the housing, for example, between the motor rotor 8 and the motor front end cover 16, and mounted on the motor output shaft 17, thereby being rotatable along with the output shaft 17. The turbine rotor blades 10 have a diameter adjusted according to the designed speed and power of the motor. The housing 9 is provided thereon with an exhaust port 13. The exhaust port 13 connects the inner cavity of the motor with the exterior. The exhaust port 13 is preferably located downstream of the turbine rotor blades to exhaust to the left the air in a chamber where the motor rotor on the right side in FIG. 1 is located. Those skilled in the art can devise that the turbine rotor blades 10 may also be mounted on, or integrated with, the motor rotor 8. For example, the motor rotor 8 may be formed into a hollow structure, and the hollow part can be used for mounting or integrating the turbine rotor blades 10. All these cases are within the protection scope of the present invention. The exhaust port 13 shown in FIG. 1 is arranged on a side wall of the housing 9. However, it is understandable for those skilled in the art that the exhaust port 13 can also be arranged on the front end cover 16 of the housing 9.

According to one example of the present invention, the exhaust device comprises multiple sets of turbine rotor blades 10, and turbine guide blades 11 are arranged between adjacent turbine rotor blades 10 to form a multi-stage turbo-suction structure. The stages of the turbo-suction structure can be determined by the factors such as the designed speed and rotor diameter of the motor. If the rotor diameter is increased, a high vacuum degree is required, and then the stages of the air pump can be added; and if the motor is designed with a high speed, the turbine efficiency is improved, and then the stages can be reduced appropriately. A three-stage turbine structure is shown in FIG. 1. Certainly, in the case of only one set of turbine rotor blades 10, no turbine guide blades 11 may be arranged downstream of the turbine rotor blades 10. If the turbine guide blades 11 are arranged between stages of the turbine rotor blades 10, this can correct the direction of air from the upstream turbine rotor blades 10 and transmit the same to the downstream turbine rotor blades 10 to improve the efficiency. The turbine sleeve 2 is sealed and fixed on the housing 9, for example, it can be fixed together with the motor housing 9 by a mechanical structure and keep sealed. A turbine rotor washer 18 can be fixed on the housing 9 or can be compressed and fixed on the turbine sleeve 2. The turbine rotor washer 18 and the housing 9, the turbine rotor washer 18 and the turbine sleeve 2, and the turbine sleeve 2 and the housing 9 keep sealed therebetween.

As shown in FIG. 1, the turbine rotor washer 18 is arranged between the turbine sleeves 2 of the motor 100 to provide an accurate working space for the turbine rotor blades 10.

According to one example of the present invention, the motor 100 further comprises a front wall 1 of a turbine exhaust cavity between the set of turbine rotor blades 10 and the motor front end cover 16, the front wall 1 of the turbine exhaust cavity mounted between the downstream of the turbine rotor blades and the front end cover 16, and keeping sealed with the housing 9.

According to one example of the present invention, the exhaust port 13 is provided thereon with a filter and/or a check valve 12. The filter, for example, is a multi-stage filter for filtering dust, sundries and moisture in the air, thereby keeping the air entering the inner cavity of the motor clean and dry. The check valve can be used for achieving the similar purposes and functions as well.

The operation of the motor 100 as shown in FIG. 1 will be described below.

When the motor 100 rotates in a set direction (for example, rotating clockwise as observed from the front of the output shaft), the output shaft drives the turbine rotor blades 10 mounted thereon to rotate, then transmit downstream and suck out air in the inner cavity of the motor, and exhaust the air out of the inner cavity of the motor through the exhaust port 13 and the filter and/or check valve 12, so as to keep the negative pressure around the motor rotor 8 in the inner cavity of the motor, thereby reducing the air resistance when the motor rotor rotates. When the motor 100 stops rotating, the external air can be filtered, from which dust, sundries and moisture are removed by the filter, and then enter the inner cavity of the motor through the exhaust port 13 to keep the internal and external pressure consistent when the motor is not working.

According to one example of the present invention, there may be only one exhaust port 13 arranged on the housing 9. When the motor 100 starts to rotate, the turbine accelerates gradually to suck out the air in the cavity around the rotor increasingly, and exhaust the same through the exhaust port. Since the volume of the cavity around the rotor is not so large and the air volume is also small, it is enough to provide only one exhaust port. When the motor reaches the working speed, the vacuum degree around the rotor also reaches and maintains the corresponding value. At this time, no air passes through the exhaust port actually. When the motor accelerates, the turbine rotor blades also speed up to suck out more air and exhaust the same through the exhaust port until the motor speed is constant; and when the motor decelerates, the turbine rotor blades also slow down at the same time, such that the air suction efficiency decreases and some air enters the motor rotor cavity from the exhaust port until the motor speed is constant. Those skilled in the art can also appreciate that the motor of the present invention may also comprise a plurality of exhaust ports 13, for example, evenly distributed along the periphery of the housing 9 for uniformly exhausting gas. All these cases are within the protection scope of the present invention.

Negative pressure through a turbine suction can bring obvious advantages.

Traditional motors generally rotate at a rate of a few thousand revolutions per minute only, and those with a rotating speed of over ten thousand revolutions per minute are regarded as high-speed motors. At this speed, the friction between a rotor and air is not enough to exert a serious impact on the performance of the motors.

However, modern neotype motors can be designed with a very high speed up to more than one hundred thousand or even hundreds of thousands of revolutions. The advantage of improving the speed is that the power density of the motors can reach a very great level, which can be widely applied in aerospace, precision machinery, robotics and other fields. With the improvement of motor speed, the friction resistance between a motor rotor and air will also have an increasingly considerable impact on the motor performance. The linear speed of the outer edge of the rotor is even close to the sound speed, affecting the motors in a huge manner. The turbo-suction solution can be adopted to make the motor rotor rotate in a highly vacuum environment, significantly reducing the friction resistance from air and improving the performance of the motors.

When the present invention is used in a one-way output shaft solution (since most motors are provided with a one-way output shaft), the rear end cover of the motor and the motor housing form a sealing structure. The only channel connecting the motor rotor with the external atmosphere consists of the set of turbine rotor blades, the set of turbine guide blades and the turbine exhaust port. When the motor works, a side of the set of turbine rotor blades close to the motor rotor is a negative pressure side, and a side close to the front wall of the turbine exhaust cavity is under the atmospheric pressure and changes slightly as the motor accelerates (the turbine exhaust cavity is in communication with the atmosphere through the exhaust port; when the motor accelerates, the turbine exhaust cavity is under the positive pressure until the motor is at a constant speed, and the pressure of the turbine exhaust cavity is equal to the air pressure outside the motor; and when the motor decelerates, the turbine exhaust cavity is under the negative pressure until the motor is at a constant speed, and the pressure of the turbine exhaust cavity is equal to the air pressure outside the motor). Because the turbine exhaust cavity is in communication with the atmosphere through the turbine exhaust port, there is no need to form the turbine exhaust cavity using a pressurized sealing structure, and all the parts including the front bearing of the motor can work in an environment of atmospheric pressure, which greatly streamlines the manufacturing process.

Without doubt, the technical solutions of the present invention are not limited to the motors with an extra-high speed, or to the motor speed, and they are also applicable to those traditional motors with thousands of revolutions or tens of thousands of revolutions. All these cases are within the protection scope of the present invention.

The examples of the present invention can be further applied to a double output shaft motor. When the double output shaft motor works, turbine rotor blades rotate, and a cavity around the rotor is evacuated to be under the negative pressure. Because the inner cavity of the rotor is in communication with the atmosphere outside the motor through a gap at the rear bearing, air enters the area of negative pressure around the rotor along the gap between the rear shaft and the rear bearing, and the gap at the bearing per se, which will result in the rising air pressure around the rotor, influence the turbo-suction effect, and even make it hardly for the negative pressure of the cavity around the rotor to reach a designed value in a serious situation. As a preferable solution, an air-tight structure can be used at the rear end of the output shaft to overcome this problem.

FIG. 4 illustrates a schematic diagram of a motor 200 according to another example of the present invention. The following contents are only about the differences between the motor 200 and the motor 100.

As shown in FIG. 4, the interior of the motor 200 does not include a turbine exhaust rotor. As a replacement of the turbine exhaust rotor, the exhaust device comprises an air pump 22 connected to the exhaust port 13 through a tube 21, such that air can be exhausted from the inner cavity of the motor 200.

The interior of the motor is evacuated by the air pump to be in a negative pressure state. At this time, the air may enter the interior of the motor along the gap between the motor shaft and the bearing, the gap at the bearing per se, and the gap between the bearing and the end cover, causing the air suction efficiency to reduce. According to one preferable embodiment mode, an air-tight structure is adopted at the end of the output shaft shown in FIG. 3 to improve the air suction efficiency.

The interior of the motor 200 shown in FIG. 4 does not include a turbine exhaust rotor. Those skilled in the art can also devise combined use of the turbine exhaust rotor (as shown in FIG. 1) inside the motor 200 with the air pump 22 to improve the air suction efficiency. All these cases are within the protection scope of the present invention.

The present invention also provides a method for exhausting air from the interior of a motor, comprising:

Starting the motor; and

Exhausting the air from an inner cavity of the motor to the exterior of a motor housing through an exhaust port on the motor housing.

According to one example of the present invention, the step of exhausting the air to the exterior of the motor housing comprises: exhausting the air from the exhaust port to the exterior of the motor housing by an air pump.

According to one example of the present invention, the step of exhausting the air to the exterior of the motor housing comprises: exhausting the air from the exhaust port to the exterior of the motor housing by one or more sets of turbine rotor blades mounted on the motor output shaft.

According to the present invention, an exhaust device, such as turbine rotor blades, is mounted on the output shaft of the motor. When the motor rotates, an inner cavity of the motor is evacuated to be in a negative pressure state; the higher the motor speed, the lower the air pressure inside the motor, the higher the vacuum degree, and the smaller the frictional resistance between a rotor and the air, so that the motor speed can be effectively increased and a rotor having a relatively large diameter can be used, thereby enhancing the low speed torque while increasing the power density of the motor and facilitating the design of a high power motor.

Last but not least, it should be noted that the contents described above are just preferable examples of the present invention, and are not used to limit the present invention. Although the detailed description of the present invention has been provided with reference to the foregoing examples, those skilled in the art still may make modifications to the technical solutions recorded in various examples described above, or conduct equivalent replacement of some technical features therein. Any modification, equivalent replacement, or improvement, if only falling into the spirit and principles as stated herein, should be included in the protection scope of the present invention.

1. A motor, comprising:
a housing;
a motor stator located in the housing;
a motor output shaft located in the housing; and
an exhaust device connected to the housing and configured to exhaust air from the interior of the housing.

2. The motor according to claim 1, wherein the housing has an exhaust port thereon, and the exhaust device comprises an air pump in communication with the exhaust port.

3. The motor according to claim 1, wherein the housing has an exhaust port thereon, the exhaust device comprises one or more sets of turbine rotor blades located in the housing and mounted on the motor output shaft or motor rotor, thereby being rotatable along with the output shaft, and the exhaust port is preferably located downstream of the turbine rotor blades.

4. The motor according to claim 3, wherein the exhaust device comprises multiple sets of turbine rotor blades, and turbine guide blades can be arranged between adjacent turbine rotor blades.

5. The motor according to claim 4, wherein the turbine guide blades are fixed on a turbine sleeve sealed and fixed on the housing.

6. The motor according to claim 3, wherein the housing comprises a front end cover, the motor further comprises a front wall of a turbine exhaust cavity, the front end cover closes one end of the housing and supports the motor output shaft, and the front wall of the turbine exhaust cavity is mounted between the downstream of the turbine rotor blades and the front end cover and keeps sealed with the housing.

7. The motor according to claim 3, wherein the exhaust port is provided thereon with a filter and/or a check valve.

8. The motor according to claim 2, wherein an output end of the motor output shaft is formed in an air-tight structure.

9. The motor according to claim 2, wherein the housing has a plurality of exhaust ports thereon.

10. The motor according to claim 6, wherein the housing further comprises a rear end cover for sealing and closing the other end of the housing and supporting the motor output shaft.

11. A method for exhausting air from the interior of a motor, comprising:
starting the motor; and
exhausting the air to the exterior of a motor housing through an exhaust port on the motor housing.

12. The method according to claim 11, wherein the step of exhausting the air to the exterior of the motor housing comprises: exhausting the air from the exhaust port to the exterior of the motor housing by an air pump.

13. The method according to claim 11, wherein the step of exhausting the air to the exterior of the motor housing comprises: exhausting the air from the exhaust port to the exterior of the motor housing by one or more sets of turbine rotor blades mounted on the motor output shaft.

14. The method according to claim 11, wherein the exhaust port is provided thereon with a filter and/or a check valve.

15. The motor according to claim 3, wherein the exhaust port is located downstream of the turbine rotor blades.
